(19) United States
(12) Patent Application Publication
(10) Pub. No.: US 2026/0195935 A1
(43) Pub. Date: Jul. 9, 2026

(54) SYSTEM AND METHOD FOR GENERATING SIGN LANGUAGE AVATARS

(71) Applicant: Lenovo (United States) Inc., Morrisville, NC (US)

(72) Inventors: Anderson Carlos Sousa e Santos, Campinas (BR); Marianna de Pinho Severo, Quixadá (BR); João Paulo Gomes de Freitas, Recife (BR); Jayne de Morais Silva, Campina Grande (BR); Silvan de Silva Junior, Parnamirim (BR); Vitor Casadei, Piracicaba (BR); Daniel Candido de Souza, Recife (BR); Jampierre Vieira Rocha, Itambacuri (BR)

(21) Appl. No.: 19/015,288

(22) Filed: Jan. 9, 2025

(51) Int. Cl. G06T 11/00

(52) U.S. Cl. CPC G06T 11/10

(57) ABSTRACT

A computer implemented method includes accessing text, generating sets of sign language keypoints for the text. Skeletons are generated for the sets of sign language keypoints. A texturing model is applied to the skeletons. The texturing model is trained on training data comprising training skeletons in interpretive poses and images of people in corresponding interpretive poses. The texturing model provides images of an avatar in interpretative poses. Intermediate keypoints may be generated and provided to the texturing model to provide intermediate poses that are aggregated with the interpretive poses to generate a video of the text being interpreted by the avatar.

### BACKGROUND

Providing an avatar to perform as a sign language interpreter is a challenging endeavor. Text, which may be recognized and transcribed from speech, is used to create keypoints corresponding to signing of the text. A texturing model receives the keypoints as an input and creates images that can be displayed to people who recognize sign language.

### SUMMARY

A computer implemented method includes accessing text, generating sets of sign language keypoints for the text. Skeletons are generated for the sets of sign language keypoints. A texturing model is applied to the skeletons. The texturing model is trained on training data comprising training skeletons in interpretive poses and images of people in corresponding interpretive poses. The texturing model provides images of an avatar in interpretative poses.

In one example, intermediate keypoints may be generated and provided to the texturing model to provide intermediate poses that are aggregated with the interpretive poses to generate a video of the text being interpreted by the avatar.

### BRIEF DESCRIPTION OF THE DRAWINGS

FIG. 1 is a block flow diagram of an improved system for creating signing images from text according to an example embodiment.

FIG. 2 is an image of an example skeleton according to an example embodiment.

FIG. 3 is a simplified table illustrating keypoints for a pose according to an example embodiment.

FIG. 4 is a block flow diagram illustrating generation and use of intermediate skeletons from sign language keypoints according to an example embodiment.

FIG. 5 is a pseudocode representation for implementing an example method for evaluating hand speed during each video and then extracting frames in lower-speed regions to use as training data according to an example embodiment.

FIG. 6 is pseudocode representation of a method of detecting peaks and valleys in a signal forming a data series according to an example embodiment.

FIG. 7 is a graph illustrating an example of hand speed distribution throughout a video according to an example embodiment.

FIG. 8 is a pseudocode representation of a method of getting peaks and valleys from hand movement velocities in videos according to an example embodiment.

FIG. 9 includes four representations of real people performing four different signs, with corresponding overlaid vectors according to an example embodiment.

FIG. 10 includes multiple preliminary skeletons corresponding to the four different signs according to an example embodiment.

FIG. 11 is a flowchart illustrating a method 1100 of selecting avatar images for sign language interpretation of received text..

FIG. 12 is a flowchart illustrating a method of selecting training data images according to an example embodiment.

FIG. 13 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Providing an avatar to perform as a sign language interpreter is a challenging endeavor. Text, or speech recognized and transcribed to create text, is used to generate keypoints corresponding to poses of a person signing the text. A texturing model receives the keypoints as an input and creates avatar images that can be displayed to people who recognize sign language. The use of an avatar can make the signing performed by a sequence of images of the avatar in different poses both easier to perceive and to understand.

In texturing, keypoints of a drawing are pre-processed before being passed to a texture index model. The keypoints are normalized prior to being passed to adjust the locations and dimensions in a skeleton space. Normalization seeks to transform the keypoints closer to a maximum reference for which the texture index model was trained.

Following normalization, the drawing (skeleton image) is created, containing the following information: a face, then a body and arms. Each member of the body will have a different color so that it is possible to differentiate these parts. Selected parts of the body are filled in, such as the face and torso. Information is then passed to the face such as eyes, eyebrows, nose and mouth. The resulting drawing (skeleton image) with all the details is passed to the texturing model to create an avatar having a pose corresponding to signing of text.

An improved method of training a texturing model translates keypoints of keypoint based training samples into image based training data. The image based training data includes images of connected body parts, referred to as a skeleton. Training of the texturing model is then performed using the image based training data. The image based training data in one example is cleaned automatically by searching for best poses in the images. The best poses may be based on images that contain varied poses and images that do not have sudden movements to avoid blurry images.

The trained texturing model can translate sample images into human avatar images which are concatenated and saved or displayed in near real time following processing delays of speech.

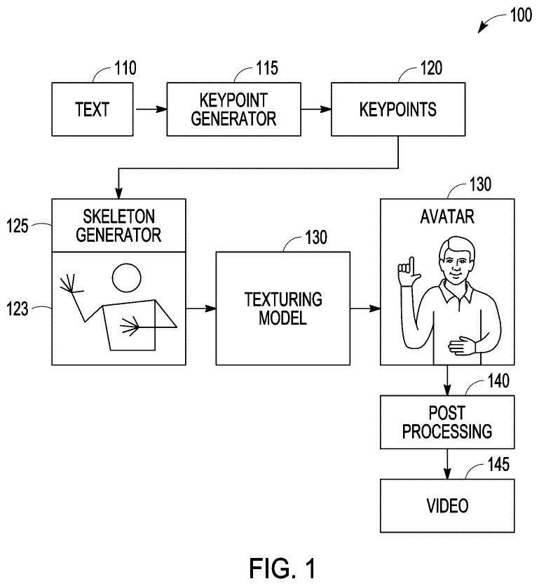

FIG. 1 is a block flow diagram of an improved system 100 for creating signing images from text 110. The text 110 may be transcribed speech in one example, or already existing text. A keypoint generator 115 receives the text and generates a series of keypoints 120 having keypoint coordinates (vector of points in space) corresponding to a set or sequence of poses used to perform interpretive signing of the text. The keypoints correspond to positions of the hands, arms, and shoulders of a person performing signing. In one example, keypoints may be predefined, with the keypoint generator 115 selecting from the predefined keypoints.

A skeleton generator 125 receives the keypoints 120 and generates a skeleton 123 for each keypoint. The skeleton 123 is drawn as an image using keypoints as connections between the limbs of the body and coloring each part separately. In one example, the keypoints 120 include sign language keypoints representative of sign language poses, intermediate keypoints, which are sets of intermediate keypoints representative of a transition between poses and may be generated based on an interpolation between the sets of keypoints representing the poses needed to sign the text 110. The inclusion of intermediate keypoints allows later concatenation of images to create a video of an avatar signing the text 110.

Output from the skeleton generator 125 is provided to a texturing model 130. The keypoints may have been normalized to adjust locations and dimensions within a maximum reference for which the texturing model 130 was trained prior to generation of the skeletons 123.

In one example, the texturing model 130 may be a convolutional GAN (Generative Adversarial Network) that is trained on pairs of aligned image pairs representing expected input and output. One image of the aligned image pairs includes a skeleton 123 generated by skeleton generator 125, and a corresponding image obtained from video of a person performing interpretative signing. Such training allows the texturing model to recognize input patterns and generate an output image, referred to as an avatar 135, corresponding to each input skeleton.

The texturing model 130 consists of a generator network that receives an image (skeleton) and returns an image of a person with the same dimensions. A discriminator network is used to return a score whether it corresponds to a real image or not-given a database of real images. The discriminator network includes a loss function for optimizing the generating network (Adversarial loss). An additional function compares the generated image directly with the real image. For this, a pre-trained convolutional network may be used to classify images and the features extracted from the two images are compared, thus measuring the degree of similarity based on perceptual loss.

The generating network in one example consists of 2 downsampling blocks, 9 residual blocks (resnet) and 2 upsampling blocks. The discriminator network is a PatchGAN, it consists of 3 downsampling blocks with the classification being carried out using the lsgan mode (Mean square loss between the real image and the evaluated image).

To speed up training and promote data augmentation, the model may be trained with random 512×512 cropping of images. As the network is fully convolutional, during inference the entire image is passed and the model will be able to process the entire image. Training with clippings appears to improve the generalization of the model, avoiding overfitting of the discriminator network. Another data augmentation applied may include horizontal mirroring, as signs can be performed with both hands without losing meaning.

To avoid repeated frames, two approaches may be used. The first approach consists of performing linear sampling avoiding consecutive frames. The approach avoids identical frames in the same video. The second approach uses a comparison between all frames based on the angles of the keypoints. This approach filters identical poses among all videos used to generate training data.

A next step is to obtain the skeleton input image, an image that best represents the adopted pose, while being agnostic to the physical characteristics. To do this, the keypoints and their connections are drawn in an image, taking care that each part of the body receives a different color

Training in one example may be carried out for 200 epochs, and after the 100^{th} epoch there is a decay in the learning rate. The initial learning rate is 0.002 and an Adam optimizer may be used.

In one example, the texturing model 130 is trained with video images of a single person signing training text or demonstrating the different poses for sign language that preferable shows different perspectives of the person, especially the hands, that are likely to be seen when posing or transitioning between poses that are likely to occur when performing interpretive signing. The amount of training data may vary in different examples. In one example, 400 videos including 20,000 images may be used to train the texturing model 130.

Post processing 140 is performed to concatenate the images to produce a video 145 of the avatar signing the text. Each video image may be adjusted to the standards of a virtual assistant application in one example or other system or display device. Post processing 140 may include cropping and padding a background. A dedicated space for subtitles may be created.

In one example, subtitle generation for the avatar may correspond to a name given for each sign in a vocabulary database. When a word is broken into several letters (dactylogy), the subtitle may be presented by accumulating the previous letters and separating them with a hyphen. One example is: “L-E-D.” Timestamps may be calculated according to video frames, such as frames per second computed by initial and final rest or pose position and transition or intermediate interpolations. The subtitle information may the saved in a dictionary allowing saving in a standardized format SRT *subRip Subtitle) and WebVTT (Web Video Text Tracks.)

Multiple different texturing models may be trained using video from different people to allow selection of different avatars having different appearances and styles of signing. In some examples, the texturing model may be retrained with a smaller set of images showing a different person in multiple different poses to enable the texturing model to select different avatars for the video 145. The term, avatar, is used to refer to the concatenated images of the single person, as it is not an actual video of the person but consists of different frames of images from the training video output by the texturing model.

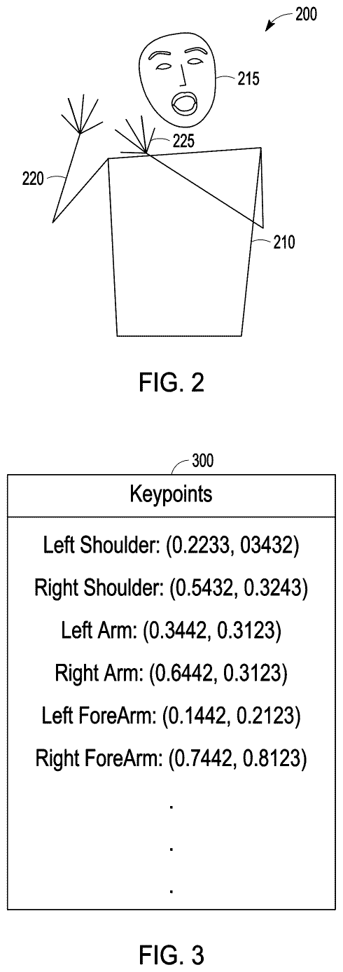

FIG. 2 is an image of an example skeleton 200. Skeleton 200 in one example is shown in a pose and includes a body 210, head 215, and arms 220 and 225. Skeleton 200 may be generated to use different colors for a face, body, and arms. Skeleton 200 may also include eyes, a nose, and a mouth. By including a body, as opposed to simple stick drawings, the skeleton enhances the ability of the texturing model 130 to differentiate the context of each part of the body and classify the skeleton 200 with a corresponding image of a person. The skeleton more closely matches features of a real person by having a body and head. The use of eyes, nose, and mouth can further help the model classify the skeleton.

FIG. 3 is a simplified table 300 illustrating keypoints for a pose. Table 300 shows a small set of keypoints, including vector of points in space for a left shoulder, right shoulder, left arm, right arm, left forearm, and right forearm. In further examples, many more keypoints may be used to represent poses.

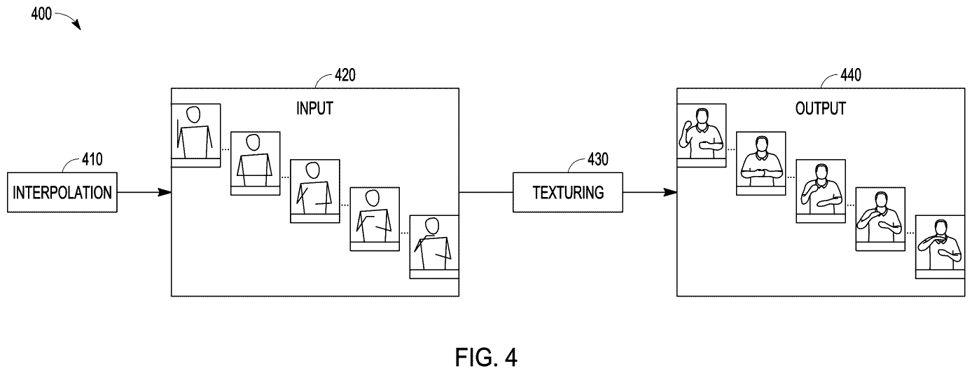

FIG. 4 is a block flow diagram illustrating generation and use of intermediate skeletons from sign language keypoints generally at 400. Interpolation 410 generates intermediate keypoints representative of a transition between consecutive poses represented by the sign language keypoints and may be generated based on an interpolation between the sets of keypoints representing the sign language poses needed to sign the text 110. The sign language keypoints and intermediate keypoints generated are converted to skeletons 420 for provision to the texturing model 430, which classifies the skeletons to generate output images 440. The inclusion of intermediate keypoints allows later concatenation of images to create a video of an avatar signing the text 110.

Output from the skeleton generator 125 is provided to a texturing model 130. The keypoints may have been normalized to adjust locations and dimensions within a maximum reference for which the texturing model 130 was trained prior to generation of the skeletons 123.

In one example, training data image selection may be performed to optimize the training data to minimize motion blur. As the images come from videos, there are many almost identical frames and also frames with motion blur, which hinder the generation of images with good definition. Assessing whether the frame contains motion blur is a problem, especially considering that it is only located in the hands region and not the entire image.

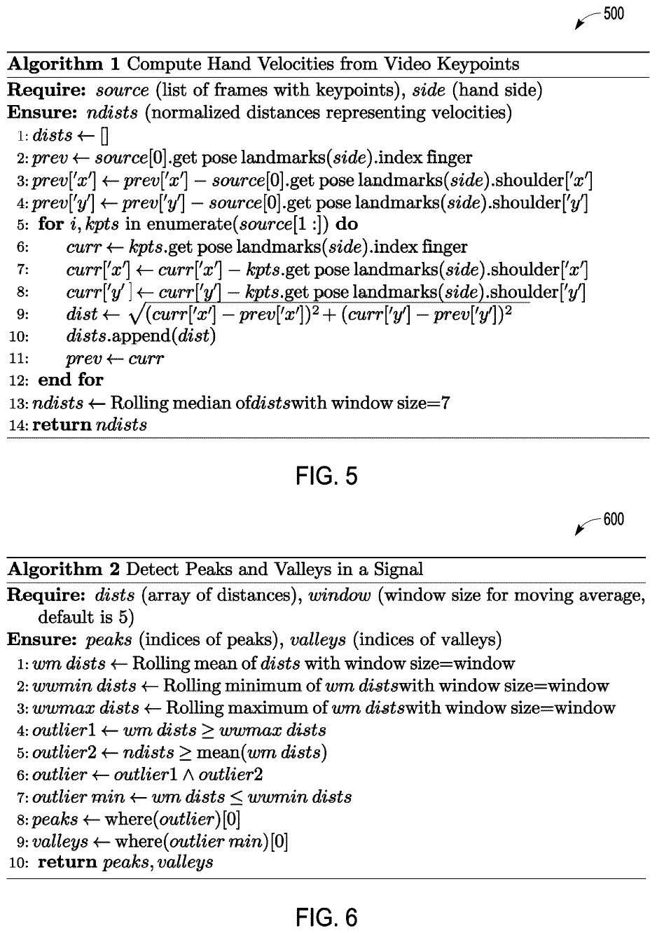

FIG. 5 is a pseudocode representation for implementing an example method 500 for evaluating hand speed during each video and then extracting frames in lower-speed regions to use as training data. The selection of such frames minimizes the probability of frames containing motion blur. Method 500 obtains a list of frames with keypoints, including keypoints related to the hand and calculates an initial or previous position of the index finger relative to the shoulder, already adjusted for relative coordinates. Method 500 then iterates over each subsequent frame in the video, recalculating and normalizing the position of the index finger relative to the shoulder for each frame, calculating a Euclidean distance between the current and previous positions to estimate the velicity. After calculating the distances for all frames, the algorithm applies a moving media with a window of 7 to smooth the date and return the normalized distances.

The method 500 uses the keypoints of the pulses, calculates the distance covered frame by frame, finds the ‘peaks’ and ‘valleys’ in this distribution and extracts only the frames in the valleys to the base.

FIG. 6 is pseudocode representation of a method 600 of detecting peaks and valleys in a signal forming a data series. Method 600 begins by normalizing the distance data (ndists) to facilitate relative comparison. A moving window is used to calculate averages, minimums, and maximums, making it easier to identify extreme points in the data series. Conditions for identifying peaks and valleys are based on comparisons with moving averages and other statistical criteria.

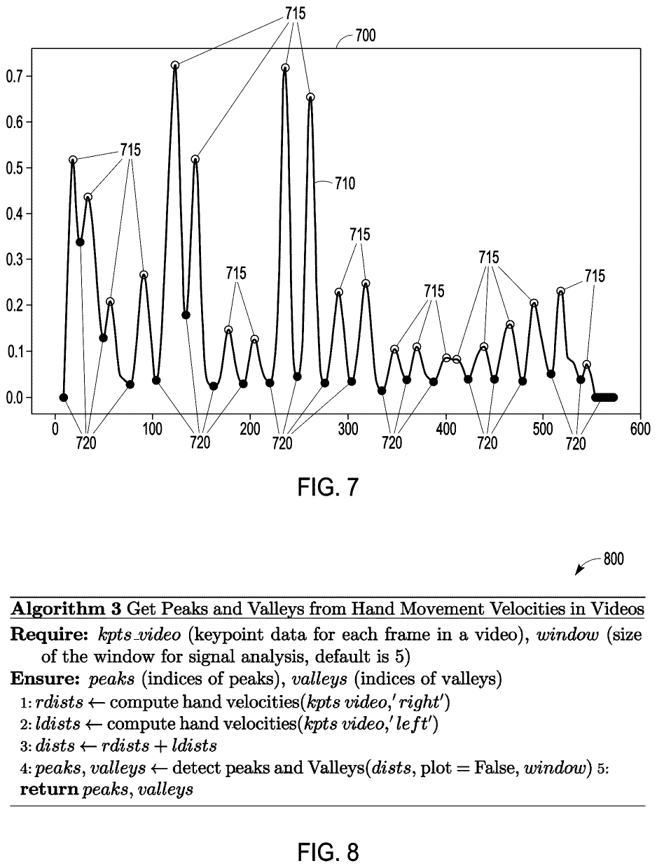

FIG. 7 is a graph 700 illustrating an example of hand speed distribution 710 throughout a video. Peaks are indicated at 715, and valleys are indicated at 720.

FIG. 8 is a pseudocode representation of a method 800 of getting peaks and valleys from hand movement velocities in videos. Method 800 utilizes both previous method 500 and 600 to compute the velocities for the both the right hand and left hand using the keypoints data from the video. The velocities of both hands are combined into a single series to analyze overall hand activity. The combined velocity series is analyzed to detect phases of high activity (peaks) and low activity (valleys) using the specified window size for analysis. Frames are selected for training data that are closer to the valleys, as they are less likely to exhibit blur.

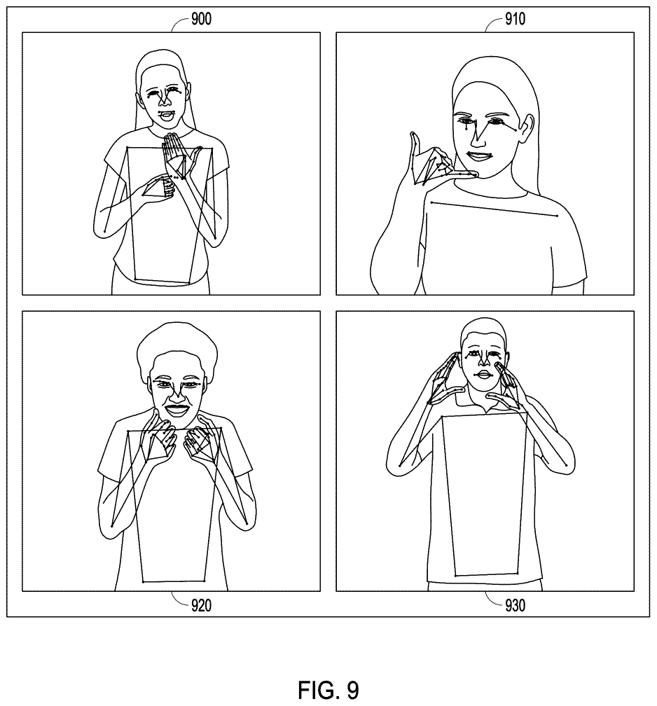

FIG. 9 includes four representations of real people at 900, 910, 920, and 930 performing four different signs, with corresponding overlaid vectors.

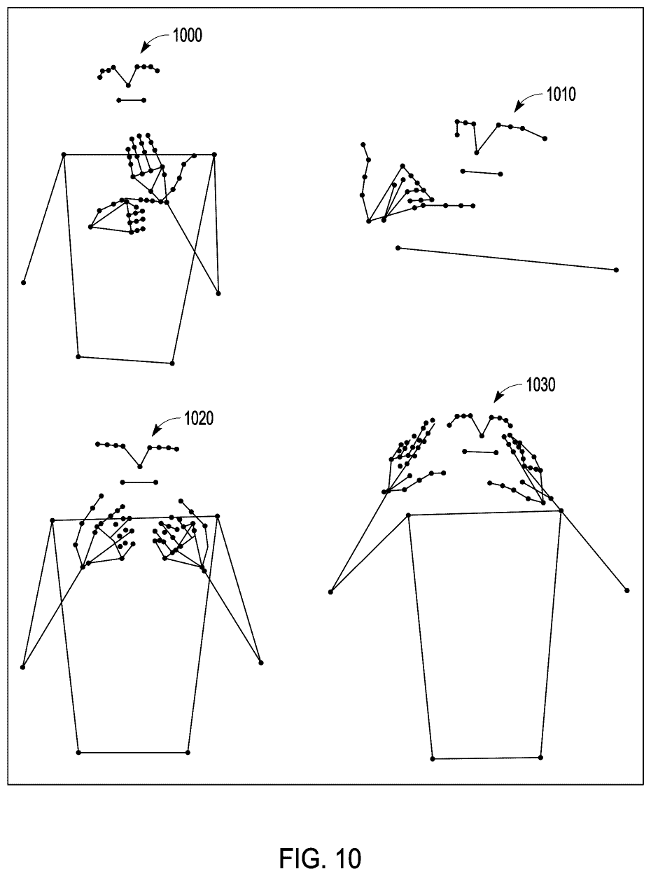

FIG. 10 includes multiple preliminary skeletons 1000, 1010, 1020, and 1030 corresponding to the four different signs. The preliminary skeletons will become finalized with color prior to being provided to the texturing model for classification.

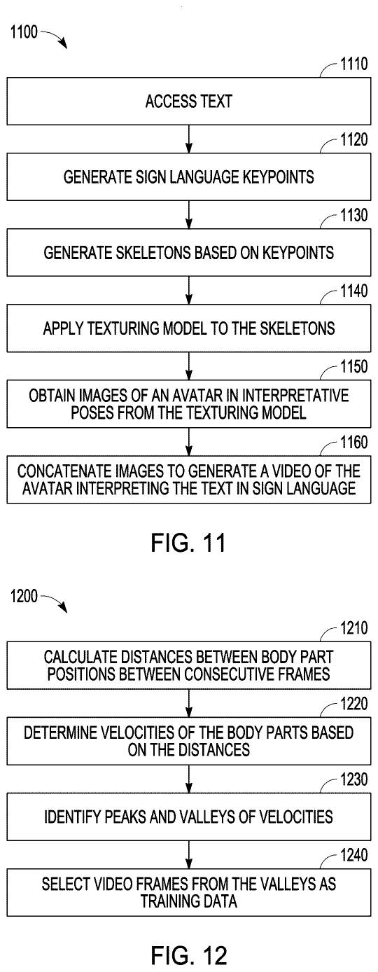

FIG. 11 is a flowchart illustrating a method 1100 of selecting avatar images for sign language interpretation of received text. Method 1100 begins at operation 1110 by accessing text for which sign language interpretation images are to be created. Sets of sign language keypoints are generated at operation 1120 for the text. In one example, the keypoints are predefined and retrieved from a table containing keypoints for text.

Skeletons are generated at operation 1130 for the sets of sign language keypoints. Operation 1140 applies a texturing model to the skeletons. The texturing model may be trained on training data that includes training skeletons in interpretive poses and images of people in corresponding interpretive poses. Operation 1150 obtains images of an avatar in interpretative poses from the texturing model. In one example, the sets of keypoints are normalized to adjust locations and dimensions within a maximum reference for which the model was trained.

In one example, generating skeletons at operation 1130 includes using different colors for a face, body, and arms. Eyes, a nose, and a mouth may also be generated. Generation of skeletons and training skeletons may be generated using a same skeleton generator.

In one example, generating skeletons at operation 1130 includes interpolating between the sets of sign language keypoints to generate sets of intermediate keypoints representing motion between the sign language keypoints. Intermediate skeletons are for the sets of intermediate keypoints. Operation 1140 applies the texturing model the intermediate skeletons. The texturing model may be further trained on the training data that includes intermediate skeletons and training data video of one or more persons signing training text. Operation 1150 includes obtaining intermediate images of an avatar in intermediate poses from the texturing model.

The obtained images of an avatar may be concatenated at operation 1160 to generate a video of the avatar interpreting the text in sign language.

FIG. 12 is a flowchart illustrating a method 1200 of selecting training data images. Method 1200 cleans training data by removing video frames that have movement caused blur. Method 1200 begins at operation 1210 calculating distances between body part positions between consecutive frames. Operation 1220 determines velocities of the body parts based on the distances. Peaks and valleys of velocities are identified at operation 1230. Operation 1240 selects video frames from the valleys as training data.

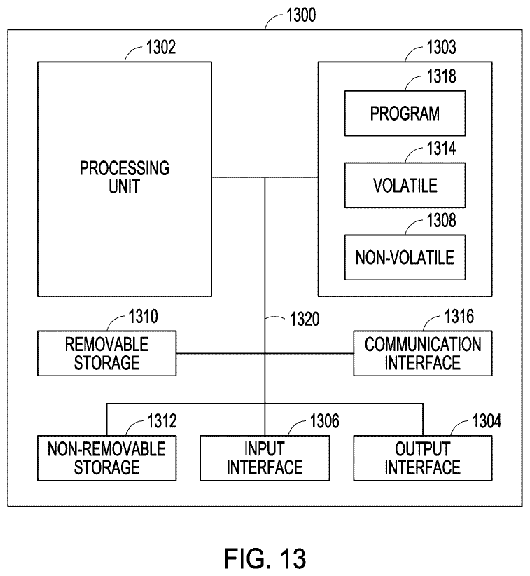

FIG. 13 is a block schematic diagram of a computer system 1300 to select avatar images for sign language interpretation of received text and for performing other methods and algorithms according to example embodiments. All components need not be used in various embodiments.

One example computing device in the form of a computer 1300 may include a processing unit 1302, memory 1303, removable storage 1310, and non-removable storage 1312. Although the example computing device is illustrated and described as computer 1300, the computing device may be in different forms in different embodiments. For example, the computing device may instead be a smartphone, a tablet, smartwatch, smart storage device (SSD), or other computing device including the same or similar elements as illustrated and described with regard to FIG. 13. Devices, such as smartphones, tablets, and smartwatches, are generally collectively referred to as mobile devices or user equipment.

Although the various data storage elements are illustrated as part of the computer 1300, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1303 may include volatile memory 1314 and non-volatile memory 1308. Computer 1300 may include—or have access to a computing environment that includes—a variety of computer-readable media, such as volatile memory 1314 and non-volatile memory 1308, removable storage 1310 and non-removable storage 1312. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1300 may include or have access to a computing environment that includes input interface 1306, output interface 1304, and a communication interface 1316. Output interface 1304 may include a display device, such as a touchscreen, that also may serve as an input device. The input interface 1306 may include one or more of a touchscreen, touchpad, mouse, keyboard, camera, one or more device-specific buttons, one or more sensors integrated within or coupled via wired or wireless data connections to the computer 1300, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1300 are connected with a system bus 1320.

Computer-readable instructions stored on a computer-readable medium are executable by the processing unit 1302 of the computer 1300, such as a program 1318. The program 1318 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1318 along with the workspace manager 1322 may be used to cause processing unit 1302 to perform one or more methods or algorithms described herein.

### EXAMPLES

1. A computer implemented method includes accessing text, generating sets of sign language keypoints for the text, generating skeletons for the sets of sign language keypoints, applying a texturing model to the skeletons, the texturing model have been trained on training data comprising training skeletons in interpretive poses and images of people in corresponding interpretive poses, and obtaining images of an avatar in interpretative poses from the texturing model.
2. The method of example 1 and further including interpolating between the sets of sign language keypoints to generate sets of intermediate keypoints representing motion between the sign language keypoints.
3. The method of example 2 and further including generating intermediate skeletons for the sets of intermediate keypoints, applying the texturing model to the intermediate skeletons, the texturing model have been further trained on the training data that includes intermediate skeletons and training data video of one or more persons signing training text, and obtaining intermediate images of an avatar in intermediate poses from the texturing model.
4. The method of example 3 and further including concatenating the obtained images of an avatar to generate a video of the avatar interpreting the text in sign language.
5. The method of any of examples 3-4 and further including cleaning the training data by removing video frames having movement caused blur.
6. The method of example 5 wherein removing video frames having movement caused blur includes calculating distances between body part positions between consecutive frames, determining velocities of the body parts based on the distances, identifying peaks and valleys of velocities, and selecting video frames from the valleys as training data.
7. The method of any of examples 1-6 wherein the sets of keypoints are normalized to adjust locations and dimensions within a maximum reference for which the model was trained.
8. The method of any of examples 1-7 wherein generating skeletons includes using different colors for a face, body, and arms.
9. The method of any of examples 1-8 wherein generating skeletons includes generating eyes, a nose, and a mouth.
10. The method of any of examples 1-9 wherein the skeletons and training skeletons are generated using a same skeleton generator.
11. A machine-readable storage device has instructions for execution by a processor of a machine to cause the processor to perform operations to perform any of the methods of examples 1-10.
19. A device includes a processor and a memory device coupled to the processor and having a program stored thereon for execution by the processor to perform operations to perform any of the methods of examples 1-10.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
accessing text;
generating sets of sign language keypoints for the text;
generating skeletons for the sets of sign language keypoints;
applying a texturing model to the skeletons, the texturing model have been trained on training data comprising training skeletons in interpretive poses and images of people in corresponding interpretive poses; and
obtaining images of an avatar in interpretative poses from the texturing model.

2. The method of claim 1 and further comprising interpolating between the sets of sign language keypoints to generate sets of intermediate keypoints representing motion between the sign language keypoints.

3. The method of claim 2 and further comprising:
generating intermediate skeletons for the sets of intermediate keypoints;
applying the texturing model to the intermediate skeletons, the texturing model have been further trained on the training data that includes intermediate skeletons and training data video of one or more persons signing training text; and
obtaining intermediate images of an avatar in intermediate poses from the texturing model.

4. The method of claim 3 and further comprising concatenating the obtained images of an avatar to generate a video of the avatar interpreting the text in sign language.

5. The method of claim 3 and further comprising cleaning the training data by removing video frames having movement caused blur.

6. The method of claim 5 wherein removing video frames having movement caused blur comprises:
calculating distances between body part positions between consecutive frames;
determining velocities of the body parts based on the distances;
identifying peaks and valleys of velocities; and
selecting video frames from the valleys as training data.

7. The method of claim 1 wherein the sets of keypoints are normalized to adjust locations and dimensions within a maximum reference for which the model was trained.

8. The method of claim 1 wherein generating skeletons comprises using different colors for a face, body, and arms.

9. The method of claim 1 wherein generating skeletons comprises generating eyes, a nose, and a mouth.

10. The method of claim 1 wherein the skeletons and training skeletons are generated using a same skeleton generator.

11. A machine-readable storage device having instructions for execution by a processor of a machine to cause the processor to perform operations to perform a method, the operations comprising:
accessing text;
generating sets of sign language keypoints for the text;
generating skeletons for the sets of sign language keypoints;
applying a texturing model to the skeletons, the texturing model have been trained on training data comprising training skeletons in interpretive poses and images of people in corresponding interpretive poses; and
obtaining images of an avatar in interpretative poses from the texturing model.

12. The device of claim 11 wherein the operations further comprise interpolating between the sets of sign language keypoints to generate sets of intermediate keypoints representing motion between the sign language keypoints.

13. The device of claim 12 wherein the operations further comprise:
generating intermediate skeletons for the sets of intermediate keypoints;
applying the texturing model to the intermediate skeletons, the texturing model have been further trained on the training data that includes intermediate skeletons and training data video of one or more persons signing training text; and
obtaining intermediate images of an avatar in intermediate poses from the texturing model.

14. The device of claim 13 wherein the operations further comprise concatenating the obtained images of an avatar to generate a video of the avatar interpreting the text in sign language.

15. The device of claim 13 wherein the operations further comprise cleaning the training data by removing video frames having movement caused blur.

16. The device of claim 15 wherein removing video frames having movement caused blur comprises:
calculating distances between body part positions between consecutive frames;
determining velocities of the body parts based on the distances;
identifying peaks and valleys of velocities; and
selecting video frames from the valleys as training data.

17. The device of claim 11 wherein the sets of keypoints are normalized to adjust locations and dimensions within a maximum reference for which the model was trained and wherein generating skeletons comprises:
using different colors for a face, body, and arms; and
generating eyes, a nose, and a mouth.

18. The device of claim 11 wherein the skeletons and training skeletons are generated using a same skeleton generator.

19. A device comprising:
a processor; and
a memory device coupled to the processor and having a program stored thereon for execution by the processor to perform operations comprising:
accessing text;
generating sets of sign language keypoints for the text;
generating skeletons for the sets of sign language keypoints;
applying a texturing model to the skeletons, the texturing model have been trained on training data comprising training skeletons in interpretive poses and images of people in corresponding interpretive poses; and
obtaining images of an avatar in interpretative poses from the texturing model.

20. The device of claim 19 wherein the operations further comprise:
interpolating between the sets of sign language keypoints to generate sets of intermediate keypoints representing motion between the sign language keypoint;
generating intermediate skeletons for the sets of intermediate keypoints;
applying the texturing model to the intermediate skeletons, the texturing model have been further trained on the training data that includes intermediate skeletons and training data video of one or more persons signing training text; and
obtaining intermediate images of an avatar in intermediate poses from the texturing model.
